(19) United States
(12) Patent Application Publication
(10) Pub. No.: US 2008/0013728 A1
(43) Pub. Date: Jan. 17, 2008

(54) Method and Device for Ensuring Data Security in Passive Optical Network

(75) Inventors: Lehong Niu, Shenzhen (CN); Min Yang, Shenzhen (CN)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Huawei Technologies Co., Ltd., Shenzhen (CN)

(21) Appl. No.: 11/770,292

(22) Filed: Jun. 28, 2007

(30) Foreign Application Priority Data
Jul. 3, 2006 (CN) 200610090369.1

(51) Int. Cl. H04K 1/00; H04B 10/00

(52) U.S. Cl. 380/256

(57) ABSTRACT

In a method for ensuring data security in a PON, when an Optical Line Terminal (OLT) configures an encryption attribute of a channel of an Optical Network Unit (ONU)/Optical Network Termination (ONT), the OLT and the ONU/ONT process plaintext data on the channel of the ONU/ONT before a key switching time and process ciphertext data using a new key on the channel at the key switching time simultaneously; when the OLT cancels the encryption attribute of a channel of the ONU/ONT, the OLT and the ONU/ONT process ciphertext data on the channel before the key switching time and process plaintext data on the channel simultaneously at the key switching time. Through the method, synchronization of encryption and decryption between the OLT and the ONU/ONT when the OLT configures or cancels the encryption attribute of a channel of the ONU/ONT is implemented.

### CROSS-REFERENCE TO RELATED APPLICATIONS

The priority benefit of Chinese Patent Application No. 200610090369.1 filed Jul. 3, 2006, the entire disclosure of which is hereby incorporated herein by reference, is claimed.

### BACKGROUND OF THE INVENTION

1. Field of the Invention

The invention relates to network communications, and particularly, to a method and device for ensuring data security in a passive optical network.

2. Background of the Invention

At present, broadband access technologies are mainly categorized into a copper access technology and an optical access technology. The copper access technology includes various Digital Subscriber Line (DSL) technologies, and an access network implemented by the optical access technology is called an Optical Access Network (OAN).

The Passive Optical Network (PON) is one of the technologies for implementing the OAN, which is a Point to Multi-Point transport technology. The basic structure of a PON system is shown in FIG. 1.

The PON system includes an Optical Line Terminal (OLT), an Optical Distribution Network (ODN) and Optical Network Units (ONUs). There may be one or more ODNs in the PON system.

The OLT provides a Service Network Interface (SNI) for the OAN and is connected to one or more ODNs.

The ODN, which is a passive optical splitter, transmits downstream data of the OLT to each ONU through splitting the energy of optical signal, and transmits converged upstream data of the ONUs to the OLT.

An ONU provides a User Network Interface (UNI) for the OAN and is connected to the ODN. The ONU may be called an Optical Network Termination (ONT) if the ONU also provides a service interface, such as an Ethernet port and a Plain Old Telephone Service (POTS) port. In the description, both an ONU and an ONT are referred to as an ONT for convenience.

In the PON system, the downstream traffic is broadcasted from the OLT to all the ONTs and each of the ONTs receives the downstream traffic needed. The OLT allocates a transmission timeslot to each of the ONTs and each of the ONTs sends data to the OLT in the transmission timeslot allocated by the OLT to the ONT. Moreover, the OLT manages the upstream traffic from each of the ONTs to the OLT.

The Giga-bit Passive Optical Network (GPON) technical standard is the latest PON technical standard. The GPON technical standard corresponds to the G984.1, G984.2, G984.3 and G984.4 series of the Telecommunicaiton Standardization Sector of International Telecommunicaiton Union (ITU-T).

The GPON technical standard provides two bearing modes for service data, i.e. the Asynchronous Transfer Mode (ATM) and the GPON Encapsulation Method (GEM). Through the ATM, the service data are encapsulated into an ATM cell with 53 bytes, and the ATM cell is then transmitted through an ATM Permanent Virtual Path (PVP) allocated by the OLT for the ONT. Through the GEM, the service data are encapsulated into a GEM encapsulation frame, and the GEM encapsulation frame is then transmitted through a GEM PORT channel allocated by the OLT for the ONT. Moreover, through the GEM, the encapsulation is carried out at a variable length, i.e., the length of the GEM encapsulation frame can be varied according to the length of the service data. The identifier of the ATM PVP is a Virtual Path Identifier (VPI) in the ATM, while the identifier of the GEM PORT channel is a PORT_ID in the GEM.

After an ONT registers in the OLT, the OLT designates an ATM PVP or a GEM PORT as the transmission channel (called channel for short hereafter) between the OLT and the ONT according to the demand of the ONT on the service data transmission, and assigns a value of the VPI or PORT_ID. The channel of the ATM PVP or the GEM PORT may be unidirectional or bidirectional and the OLT may allocate multiple channels for one ONT.

In the PON system, the downstream data are broadcasted from the OLT to all the ONTs. Although each of the ONTs is required to receive downstream data on its own channel, an ONT can receive downstream data on other channels if a vicious subscriber re-programmes the ONT. In this case, the ONT may intercept all the downstream data from the OLT to the other ONTs.

FIG. 2 is a flowchart illustrating a conventional method for ensuring data security. The conventional method is described in detail below. The ONU in FIG. 2 could be the ONT also.

In the solution of the existing GPON technical standard, the data security is ensured by encrypting the downstream data from the OLT to the ONTs. The minimum unit encrypted is a channel allocated by the OLT for the ONT, i.e., an ATM PVP or a GEM PORT. A key of the encryption is generated and provided to the OLT by the ONT. Each of the channels of one ONT may be configured as encrypted or not encrypted.

With respect to the OLT, it encrypts, based on the key provided by the ONT, the downstream transmission data of the channel of the ONT configured with an encryption attribute. With respect to the ONT, it decrypts the downstream transmission data using the key. The ONT can decrypt only its own downstream transmission data because keys provided by different ONTs to the OLT are different. Thus, the privacy of the transmission of the downstream transmission data is ensured. The ONT is informed by the OLT that the channel is configured with the encryption attribute through an Encrypted_Port_ID/VPI message, and all the channels of one ONT share one key.

The key is updated periodically to ensure the security of the key. The key update is initiated by the OLT and the period for the key update may be configured. Specifically, the process of the key update is described below.

The OLT requests an ONT to generate a new key by sending a Request Key message to the ONT. Upon receiving the Request Key message, the ONT generates a new key and sends the new key to the OLT through an Encryption Key message. Moreover, a synchronization mechanism is needed for starting to use the new key so as to ensure that the key for encryption in the OLT and the key for decryption in the ONT are the same, in other words, upon receiving the Encryption Key message sent by the ONT, the OLT determines the time for starting to use the new key and sends the time for starting to use the new key to the ONT through a Key Switching Time message. When it is at the time for starting to use the new key, the OLT starts to use the new key for encryption and the ONT starts to use the new key for decryption at the same time.

The inventor of the invention finds the following disadvantages of the conventional method above. If an encrypted channel configured by the OLT for an ONT is the first encrypted channel of the ONT, as shown in FIG. 2, the OLT sends an Encrypted_Port_ID/VPI message to the ONT first; upon receiving an encrypted channel configuration response message returned by the ONT, the OLT initiates a key request procedure immediately because the OLT has not acquired the key of the ONT before, in other words, the OLT sends a Request Key message to the ONT to acquire the key of the ONT. When it is key switching time, the OLT starts to use the new key for encryption and the ONT starts to use the new key for decryption at the same time. Thus, the encryption and decryption using the same key at the same time is realized between the OLT and the ONT.

FIG. 3 is a flowchart illustrating a conventional method for configuring an encryption attribute for a second channel. The ONU in FIG. 2 could be the ONT also. For description convenience, both ONU and ONT are referred to as the ONT. As shown in FIG. 3, if the OLT configures another encrypted channel for the ONT, because the ONT has already had the key, the ONT will start to process the data of the encrypted channel as the encrypted data immediately (i.e., at time 1) upon returning an encrypted channel configuration response message to the OLT after the ONT receives an Encrypted_Port_ID/VPI message for the encrypted channel sent by the OLT. However it is possible that the OLT has not received or finished processing the encrypted channel configuration response message returned by the ONT, and the data sent by the OLT at this moment are not encrypted yet. The OLT encrypts the data to be sent only when receiving the encrypted channel configuration response message (i.e. at time 2). Thus, the ONT cannot parse the data accurately because the time for the OLT to start to encrypt and send the data is different from the time for the ONT to start to receive and decrypt the data. As a result, the service is interrupted for the moment.

Similarly, if the OLT needs to cancel the encryption attribute of an encrypted channel of the ONT, after the ONT receives an encrypted channel cancellation message for the encrypted channel sent by the OLT, the ONT immediately starts to process the data of the encrypted channel as plaintext data upon returning an encrypted channel cancellation response message to the OLT. However it is possible that the OLT has not received or finished processing the encrypted channel cancellation response message returned by the ONT, and the data sent by the OLT at this moment are still encrypted. As a result, the ONT cannot parse the data accurately, and the service is interrupted for the moment.

### SUMMARY OF THE INVENTION

According to an embodiment of the invention, a method for ensuring data security in a Passive Optical Network (PON) in which an encryption attribute has been configured for at least one channel of an Optical Network Unit (ONU)/Optical Network Termination (ONT), including:

when configuring, by an Optical Line Terminal (OLT), an encryption attribute for a second channel of the ONU/ONT, processing, by the OLT and the ONU/ONT, plaintext data on the second channel of the ONU/ONT before a key switching time; and

processing, by the OLT and the ONU/ONT, ciphertext data on the second channel using a new key simultaneously at the key switching time.

According to an embodiment of the invention, a method for ensuring data security in a Passive Optical Network (PON) includes:

when cancelling, by an Optical Line Terminal (OLT), an encryption attribute of a channel of an Optical Network Unit (ONU)/Optical Network Termination (ONT), processing, by the OLT and the ONU/ONT, ciphertext data on the channel before a key switching time; and processing, by the OLT and the ONU/ONT, plaintext data on the channel of the ONU/ONT simultaneously at the key switching time.

According to an embodiment of the invention, a method for ensuring data security in a Passive Optical Network (PON) includes:

when configuring, by an Optical Line Terminal (OLT), an encryption attribute for a channel for an Optical Network Unit (ONU)/Optical Network Termination (ONT), processing, by the OLT and the ONU/ONT, plaintext data on the channel of the ONU/ONT before a key switching time; and processing, by the OLT and the ONU/ONT, ciphertext data on the channel using a new key simultaneously at the key switching time.

An Optical Line Terminal (OLT) includes:

a component for determining whether it is key switching time, and

a component for processing plaintext data on a channel of an Optical Network Unit (ONU)/Optical Network Termination (ONT) before the key switching time when configuring an encryption attribute for the channel of the ONU/ONT; and

a component for processing ciphertext data on the channel using a new key at the key switching time simultaneously with the ONU/ONT.

Preferably, the OLT further includes: a component for processing ciphertext data on a channel of the ONU/ONT before the key switching time when cancelling the encryption attribute of the channel of the ONU/ONT; and

a component for processing plaintext data on the channel of which the encryption attribute is cancelled using a new key at the key switching time simultaneously with the ONU/ONT.

A device for ensuring data security in a Passive Optical Network (PON) includes:

a component for determining whether it is key switching time;

a component for processing plaintext data on a channel of the device before the key switching time when configuring an encryption attribute for the channel of the device; and

a component for processing ciphertext data on the channel of the device using a new key at the key switching time simultaneously with an Optical Line Terminal (OLT).

Preferably, the device further includes a component for processing ciphertext data on a channel of the device before the key switching time when cancelling the encryption attribute of the channel of the device; and a component for processing plaintext data on the channel of which encryption attribute is cancelled at the key switching time simultaneously with the OLT.

The device may be an Optical Network Unit (ONU) or an Optical Network Termination (ONT).

As can be seen from the above technical solutions provided by the embodiments of the invention, data encryption of the OLT and data decryption of the ONU/ONT are performed using a new key simultaneously at the key switching time predetermined. Or the encryption attribute of the ONU/ONT and the OLT are cancelled simultaneously at the key switching time. Therefore, the synchronization of the encryption or the decryption between the ONU/ONT and the OLT is realized, the problem of temporary data loss and service interruption when an encrypted channel is configured through the existing GPON technology is solved.

### BRIEF DESCRIPTION OF THE DRAWINGS

FIG. 1 is a schematic diagram illustrating the basic structure of a PON system.

FIG. 2 is a flowchart for illustrating a conventional method for ensuring data security.

FIG. 3 is a flowchart illustrating a conventional method for configuring an encryption attribute for a second channel.

FIG. 4 is a flowchart of the processing in accordance with an embodiment of the invention.

FIG. 5 is a flowchart of the processing in accordance with an embodiment of the invention.

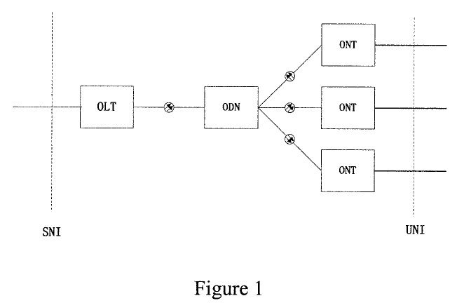

### DETAILED DESCRIPTION OF THE PREFERRED EMBODIMENTS

Embodiments of the invention provide a method for ensuring data security in a PON. According to the embodiments, at the key switching time predetermined, an OLT and an ONT simultaneously start to use a new key to perform data encryption and data decryption respectively, or the OLT and the ONT simultaneously cancel the encryption attribute of a transmission channel (called channel for short).

The embodiments of the invention are described in detail with reference to the accompanying drawings. With respect to an OLT configuring the encryption attribute of a channel of an ONT, three embodiments of the invention are provided to describe the method of ensuring the data security. As shown in FIG. 4, the processing according to an embodiment of the invention is described below. The ONU in FIG. 4 could be also the ONT, and for description convenience, both ONU and ONT are referred to as the ONT in this embodiment.

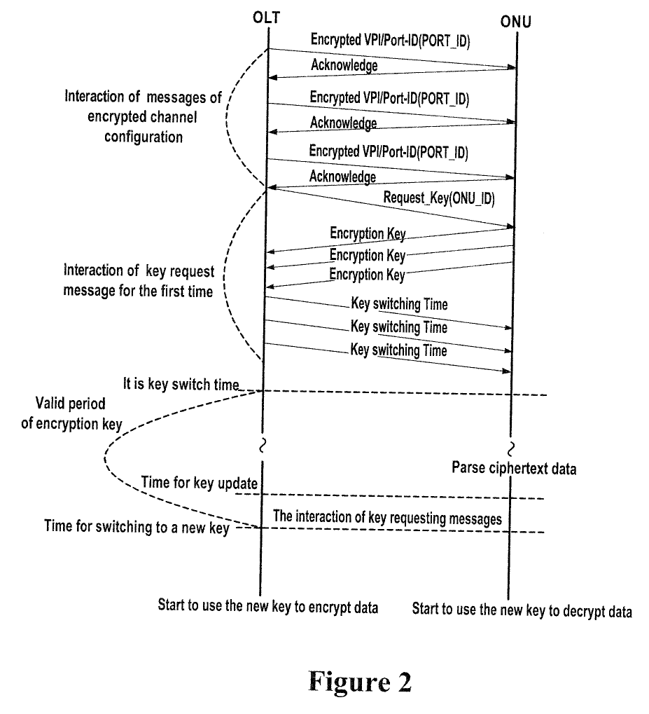

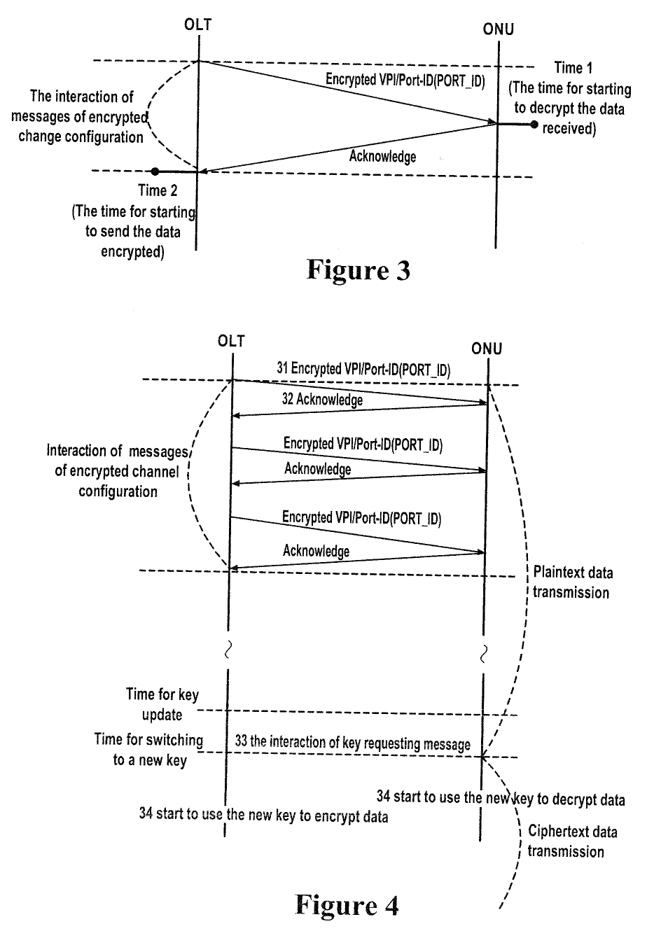

31: when the OLT configures the first encrypted channel of the ONT, the OLT configures the encrypted channel and updates the key according to the conventional method shown in FIG. 2.

When configuring the encryption attribute for another channel of the ONT, the OLT sends an encrypted channel configuration message for the channel to the ONT, and the ONT returns an encrypted channel configuration response message to the OLT upon receiving the encrypted channel configuration message. The ONT then still receives the data of the channel in a receiving mode for data not encrypted.

In practical applications, both the encrypted channel configuration message and the encrypted channel configuration response message are sent three times to ensure reliability.

32: the OLT still sends the data of the channel in a transmitting mode for data not encrypted upon receiving the encrypted channel configuration response message returned by the ONT.

33: the OLT and the ONT perform the interaction of key requesting messages when it is time for next key update predetermined by the PON system. Specifically, the OLT sends a key request message to the ONT, and the ONT generates a new key with 128 bits and sends the new key to the OLT in three times. Thus, the OLT receives the new key generated by the ONT.

The OLT determines the time for next key switch and sends the time for next key switching to the ONT with a key switching time message.

In practical applications, the key switching time message is sent three times to ensure reliability.

34: when it is time for next key switching, the OLT updates the keys of the encrypted channels configured for the ONT previously and the key of the encrypted channel configured this time to the new key, and starts to use the new key to encrypt the data of all the encrypted channels, and the ONT starts to use the new key to decrypt all the data received on the encrypted channels at the same time.

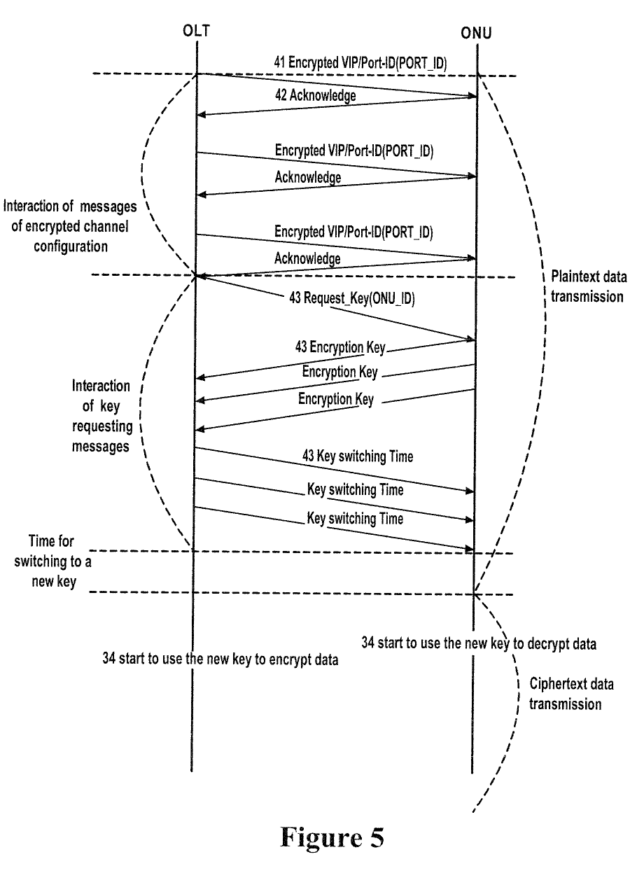

If the period for updating a key is long, for example, the key is updated every 24 hours, it may be a very long time before starting the transmission of encrypted data if the synchronization of data encryption of a channel is ensured according to the method of this embodiment. Therefore, another embodiment is provided for improving the method in the embodiment above. As shown in FIG. 5, the processing is described below. The ONU in FIG. 5 could be the ONT also, and for description convenience, both ONU and ONT are referred to as the ONT in this embodiment.

41: when the OLT configures the first encrypted channel of the ONT, the OLT configures the encrypted channel and updates the key according to the conventional method shown in FIG. 2.

When configuring the encryption attribute of another channel of the ONT, the OLT sends an encrypted channel configuration message for the channel to the ONT, and the ONT returns an encrypted channel configuration response message to the OLT upon receiving the encrypted channel configuration message. The ONT then still receives the data of the channel in the receiving mode for data not encrypted.

In practical applications, both the encrypted channel configuration message and the encrypted channel configuration response message are sent three times to ensure reliability.

42: the OLT still sends the data of the channel in the transmitting mode for data not encrypted upon receiving the encrypted channel configuration response message returned by the ONT, and starts an interaction process of the key update with the ONT whether it is time for updating a key or not.

43: the OLT and the ONT perform the interaction of key requesting messages. More particularly, the OLT sends a key request message to the ONT, and the ONT generates a new key with 128 bits and sends the new key to the OLT in three times. Thus, the OLT receives the new key generated by the ONT.

The OLT determines the time for next key switching and sends to the ONT the time for next key switching through a key switching time message.

In practical applications, the key switching time message is sent three times to ensure reliability.

44: when it is time for next key switching, the OLT updates the keys of the encrypted channels configured for the ONT previously and the key of the encrypted channel configured this time to the new key, and starts to use the new key to encrypt the data of all the encrypted channels. At the same time, the ONT starts to use the new key to decrypt all the data received on the encrypted channels.

In another embodiment of the invention, the processing is described below. For description convenience, both ONU and ONT are referred to as the ONT in this embodiment.

When the OLT configures the first encrypted channel of the ONT, the OLT configures the encrypted channel and updates the key according to the conventional method shown in FIG. 2.

When configuring the encryption attribute of another channel of the ONT, the OLT sends an encrypted channel configuration message for the channel to the ONT, and the ONT returns an encrypted channel configuration response message to the OLT upon receiving the encrypted channel configuration message. The ONT then still receives the data of the channel in the receiving mode for data not encrypted.

In practical applications, both the encrypted channel configuration message and the encrypted channel configuration response message are sent three times to ensure reliability.

The OLT sends the data of the channel in the transmitting mode for data not encrypted upon receiving the encrypted channel configuration response message returned by the ONT.

A time threshold is set in the ONT according to this embodiment, if the interval between the current time and the time for next key update predetermined by the PON system is smaller than the time threshold, the OLT and the ONT perform the interaction of key update when it is time for next key update predetermined by the PON system. The PON system may set periods for updating a key, and the key will be thus updated periodically according to the periods.

If the interval between the current time and the time for next key update predetermined by the PON system is greater than the time threshold, the interaction of key update between the OLT and the ONT is performed immediately.

At the key switching time, the OLT updates the keys of the encrypted channels configured for the ONT previously and the key of the encrypted channel configured this time to the new key, and starts to use the new key to encrypt the data of all the encrypted channels. At the same time, the ONT starts to use the new key to decrypt all the data received on the encrypted channels.

To sum up, according to the embodiments of the invention, the synchronization of encryption and decryption between the OLT and the ONT can be ensured when the OLT configures an encrypted channel for the ONT.

Additionally, the method provided by the embodiments of the invention is applicable to the process of the OLT cancelling the encryption attribute of an encrypted channel of the ONT. The process of the OLT cancelling the encryption attribute of an encrypted channel of the ONT is described below.

The OLT sends to the ONT an encrypted channel cancellation message for a channel when the OLT cancels the encryption attribute of the channel of the ONT. The ONT returns an encrypted channel cancellation response message to the OLT upon receiving the encrypted channel cancellation message, and still decrypts the data received on the channel using the key of other channels of the ONT.

The OLT still processes and sends ciphertext data on the channel upon receiving the encrypted channel cancellation response message. The OLT sends a key request message to the ONU/ONT at a predetermined time, and the ONU/ONT generates a new key and sends to the OLT a key response message containing the new key upon receiving the key request message.

Upon receiving the key response message, the OLT sends a key switching time message containing key switching time to the ONT. At the key switching time, the OLT processes and sends plaintext data on the channel, while the ONT receives and processes the plaintext data on the channel.

The predetermined time may be set as: the OLT sends the key request message to the ONU/ONT immediately upon receiving encrypted channel cancellation response message; or the OLT sends the key request message to the ONU/ONT when it is time for next key update predetermined by the PON system; or the OLT determines a time threshold, if the interval between the current time and the time for next key update predetermined by the PON system is smaller than the time threshold, the OLT sends the key request message to the ONU/ONT when it is time for next key update predetermined by the PON system; otherwise, the OLT sends the key request message to the ONU/ONT immediately.

The foregoing are only preferred embodiments of the invention. The protection scope of the invention, however, is not limited to the above description. Any change or substitution, within the technical scope disclosed by the invention, easily occurring to those skilled in the art should be covered by the protection scope of the invention. Therefore, the protection scope of the invention should be according to the claims.

What is claimed is:

1. A method for ensuring data security in a Passive Optical Network (PON) in which an encryption attribute has been configured for at least one channel of an Optical Network Unit (ONU)/Optical Network Termination (ONT), comprising:
when configuring, by an Optical Line Terminal (OLT), an encryption attribute for a second channel of the ONU/ONT, processing, by the OLT and the ONU/ONT, plaintext data on the second channel of the ONU/ONT before a key switching time; and
processing, by the OLT and the ONU/ONT, ciphertext data on the second channel using a new key simultaneously at the key switching time.

2. The method of claim 1, further comprising:
obtaining, by the OLT, the new key generated by the ONU/ONT and determining the key switching time; wherein the processing the ciphertext data comprises:
sending, by the OLT, data encrypted by the new key generated by the ONU/ONT on all channels of the ONU/ONT configured with the encryption attribute at the key switching time; and
decrypting, by the ONU/ONT, the data sent by the OLT using the new key generated by the ONU/ONT on all channels of the ONU/ONT configured with the encryption attribute at the key switching time.

3. The method of claim 1, wherein the configuring the encryption attribute comprises:
sending, by the OLT, an encrypted channel configuration message of the second channel to the ONU/ONT; and
receiving, by the OLT, an encrypted channel configuration response message returned by the ONU/ONT when the ONU/ONT receives the encrypted channel configuration message; and
the processing the plaintext data on the second channel comprises:
receiving and processing, by the ONU/ONT, the plaintext data on the second channel of the ONU/ONT upon returning the encrypted channel configuration response message; and
processing and sending, by the OLT, the plaintext data on the second channel of the ONU/ONT upon receiving the encrypted channel configuration response message.

4. The method of claim 2, wherein the obtaining the new key generated by the ONU/ONT comprises:
sending a key request message to the ONU/ONT at a predetermined time;
receiving a key response message containing the new key generated by the ONU/ONT, wherein the ONU/ONT generates the new key upon receiving the key request message; and
sending a key switching time message containing the key switching time to the ONU/ONT upon receiving the key response message.

5. The method of claim 4, wherein the sending the key request message to the ONU/ONT comprises one of the processes of:
sending the key request message to the ONU/ONT immediately upon receiving the encrypted channel configuration response message;
sending the key request message to the ONU/ONT when it is time for next key update;
sending the key request message to the ONU/ONT when it is time for the next key update if an interval between a current time and the time for the next key update is smaller than a time threshold; and
sending the key request message to the ONU/ONT immediately if an interval between the current time and the time for the next key update is greater than the time threshold.

6. The method of claim 1, wherein the PON is a PON based on Giga-bit Passive Optical Network (GPON) technical standard.

7. A method for ensuring data security in a Passive Optical Network (PON), comprising:
when cancelling, by an Optical Line Terminal (OLT), an encryption attribute of a channel of an Optical Network Unit (ONU)/Optical Network Termination (ONT), processing, by the OLT and the ONU/ONT, ciphertext data on the channel of the ONU/ONT before a key switching time; and
processing, by the OLT and the ONU/ONT, plaintext data on the channel of the ONU/ONT simultaneously at the key switching time.

8. The method of claim 7, further comprising:
obtaining, by the OLT, a key generated by the ONU/ONT, and determining the key switching time; wherein the processing the plaintext data on the channel of the ONU/ONT simultaneously comprises:
sending, by the OLT, the plaintext data on the channel at the key switching time, wherein the encryption attribute of the channel is cancelled; and
receiving, by the ONU/ONT, the plaintext data on the channel at the key switching time, wherein the encryption attribute of the channel is cancelled.

9. The method of claim 8, wherein the cancelling the encryption attribute of the channel of the ONU/ONT comprises:
sending, by the OLT, an encrypted channel cancellation message of the channel to the ONU/ONT; and
receiving, by the OLT, an encrypted channel cancellation response message returned by the ONU/ONT when the ONU/ONT receives the encrypted channel cancellation message; and
the processing the ciphertext data on the channel before the key switching time comprises:
receiving and processing, by the ONU/ONT, the ciphertext data on the channel upon returning the encrypted channel cancellation response message; and
processing and sending, by the OLT, the ciphertext data on the channel upon receiving the encrypted channel cancellation response message.

10. The method of claim 9, wherein the obtaining the key generated by the ONU/ONT comprises:
sending a key request message to the ONU/ONT at a predetermined time;
receiving a key response message which is sent by the ONU/ONT and contains the key generated by the ONU/ONT, wherein the ONU/ONT sends the key response message upon receiving the key request message; and
sending a key switching time message containing the key switching time to the ONU/ONT upon receiving the key response message.

11. The method of claim 10, wherein the sending the key request message to the ONU/ONT comprises one of the processes of:
sending the key request message to the ONU/ONT immediately;
sending the key request message to the ONU/ONT when it is time for next key update;
sending the key request message to the ONU/ONT when it is time for the next key update if an interval between a current time and the time for the next key update is smaller than a time threshold; and
sending the key request message to the ONU/ONT immediately if an interval between the current time and the time for the next key update is greater than the time threshold.

12. A method for ensuring data security in a Passive Optical Network (PON), comprising:
when configuring, by an Optical Line Terminal (OLT), an encryption attribute for a channel for an Optical Network Unit (ONU)/Optical Network Termination (ONT), processing, by the OLT and the ONU/ONT, plaintext data on the channel of the ONU/ONT before a key switching time; and
processing, by the OLT and the ONU/ONT, ciphertext data on the channel using a new key simultaneously at the key switching time.

13. The method of claim 12, further comprising:
obtaining, by the OLT, the new key generated by the ONU/ONT and determining the key switching time; wherein the processing the ciphertext data using the new key simultaneously on the channel configured with the encryption attribute comprises:
sending, by the OLT, data encrypted by the new key generated by the ONU/ONT at the key switching time on all channels of the ONU/ONT which are configured with the encryption attribute; and
decrypting, by the ONU/ONT, the data received at the key switching time using the new key generated by the ONU/ONT on all channels of the ONU/ONT which are configured with the encryption attribute.

14. An Optical Line Terminal (OLT), comprising:
a component for determining whether it is key switching time, and a component for processing plaintext data on a channel of an Optical Network Unit (ONU)/Optical Network Termination (ONT) before the key switching time when configuring an encryption attribute for the channel of the ONU/ONT; and
a component for processing ciphertext data on the channel using a new key at the key switching time simultaneously with the ONU/ONT.

15. The OLT of claim 14, further comprising: a component for processing ciphertext data on a channel of the ONU/ONT before the key switching time when cancelling the encryption attribute of the channel of the ONU/ONT; and
a component for processing plaintext data on the channel of which the encryption attribute is cancelled using a new key at the key switching time simultaneously with the ONU/ONT.

16. The OLT of claim 15, further comprising:
a component for obtaining the new key generated by the ONU/ONT; and
a component for determining the key switching time; and
a component for sending a key switching time message containing the key switching time.

17. A device for ensuring data security in a Passive Optical Network (PON), comprising:
a component for determining whether it is key switching time, and a component for processing plaintext data on a channel of the device before the key switching time when configuring an encryption attribute for the channel of the device; and
a component for processing ciphertext data on the channel of the device using a new key at the key switching time simultaneously with an Optical Line Terminal (OLT).

18. The device of claim 17, further comprising:
a component for processing ciphertext data on a channel of the device before the key switching time when cancelling the encryption attribute of the channel of the device; and
a component for processing plaintext data on the channel of which the encryption attribute is cancelled at the key switching time simultaneously with the OLT.

19. The device of claim 17, further comprising:
a component for generating the new key, and a component for sending the new key.

20. The device of claim 17, further comprising:
a component for receiving a key switching time message containing the key switching time.

21. The device of claim 17, wherein the device is an Optical Network Unit (ONU) or an Optical Network Termination (ONT).
